(19) United States
(12) Patent Application Publication
(10) Pub. No.: US 2024/0362589 A1
(43) Pub. Date: Oct. 31, 2024

(54) Collaborative Intelligence System

(71) Applicant: Casey McCann, Colorado Springs, CO (US)

(72) Inventor: Casey McCann, Colorado Springs, CO (US)

(21) Appl. No.: 18/765,314

(22) Filed: Jul. 7, 2024

(51) Int. Cl. G06Q 10/101

(52) U.S. Cl. CPC G06Q 10/101

(57) ABSTRACT

The present invention relates to a system and method for generating and managing insights through collaborative ideation among AI personas. The system leverages a multidimensional array data structure to store and organize insights, along with associated metadata like task stage, progress, expected delivery, and documentation. Each insight is linked to relevant personas to tap into their unique expertise and perspectives. The system also includes a metadata governance framework to ensure data consistency, accuracy and completeness. Regular check-ins, user feedback, and continuous improvement drive the ideation process. The Collaborative Intelligence System enables efficient generation, management and application of insights to drive innovation and business value.

### BACKGROUND

Existing approaches to collaborative ideation and insight generation often rely on manual processes, siloed data storage, and lack of clear governance. This leads to inefficiencies, inconsistencies and missed opportunities. There is a need for an automated, scalable system that can harness the power of collective intelligence to drive innovation.

### INVENTION SUMMARY

The Collaborative Intelligence System addresses these challenges by:
1. Enabling collaborative ideation among AI personas with defined roles, skills and relationships
2. Storing insights and associated metadata in a flexible multidimensional array data structure
3. Linking insights to relevant personas to leverage their unique expertise and perspectives
4. Implementing a metadata governance framework to ensure data quality and consistency
5. Driving continuous improvement through regular check-ins, user feedback and iterative refinement

### Key Components:

Persona definitions with role, skills, functions, description and relationships
Multidimensional array data structure to store insights and metadata
Metadata governance framework with standards, processes, stewardship roles and quality checks
Ideation process with regular check-ins, user feedback and improvement cycles

### ADVANTAGES

Harnesses collective intelligence of AI personas to generate high-quality insights
Flexible, scalable data structure enables efficient storage and retrieval of insights
Metadata governance ensures data integrity and enables rich analysis and insights
Continuous improvement drives innovation and keeps system relevant and valuable

1. A Collaborative Intelligence System for generating and managing insights, comprising: A plurality of AI personas with defined roles, skills, functions, descriptions and relationships

2. The system of claim 1, wherein each insight is linked to one or more relevant personas to leverage their expertise and perspectives.

3. The system of claim 1, wherein the multidimensional array enables flexible storage and retrieval of insights based on metadata like task stage, progress, expected delivery and documentation.

4. The system of claim 1, wherein the metadata governance framework includes standards, processes, stewardship roles and quality checks to maintain data integrity.

5. The system of claim 1, wherein the ideation process drives continuous improvement through regular check-ins to review progress, identify roadblocks and maintain alignment.

6. The system of claim 1, wherein user feedback and metrics are continuously gathered to evaluate performance and effectiveness, informing future improvements.

7. A method for generating and managing insights using the Collaborative Intelligence System of claim 1, comprising the steps of: Generating insights through collaborative ideation among AI personas

8. The method of claim 7, further comprising the step of analyzing insights and metadata to surface trends, patterns and opportunities to drive innovation.

9. The method of claim 7, further comprising the step of verifying information independently when using AI tools for critical tasks, as AI models can make mistakes.

10. The method of claim 7, further comprising the step of prioritizing transparency and communication throughout the ideation and evaluation process to ensure stakeholder alignment.
By implementing the Collaborative Intelligence System and following the claimed method, organizations can harness the power of collective intelligence to drive innovation, improve decision-making and achieve business objectives. The system's flexible architecture and continuous improvement process ensure its long-term relevance and value.
